(19) United States
(12) Patent Application Publication
(10) Pub. No.: US 2025/0353122 A1
(43) Pub. Date: Nov. 20, 2025

(54) MACHINING DEVICE AND METHOD FOR REPAIRING AN ANNULAR WORKPIECE

(71) Applicant: SAFRAN NACELLES, Gonfreville-L'Orcher (FR)

(72) Inventors: Frederic AMBLARD, Moissy-Cramayel (FR); Robin PANVERT, Moissy-Cramayel (FR); Lucas LEMAITRE, Moissy-Cramayel (FR)

(21) Appl. No.: 19/137,557

(22) PCT Filed: Dec. 13, 2023
(86) PCT No.: PCT/FR2023/051994

§ 371 Date: Jun. 10, 2025

(30) Foreign Application Priority Data
Dec. 15, 2022 (FR) 2213417

(51) Int. Cl. B23P 6/00; F01D 25/24

(52) U.S. Cl. CPC B23P 6/002; F01D 25/243; F05D 2230/10; F05D 2230/80

(57) ABSTRACT

A machining device for machining an annular workpiece, in particular a turbomachine, wherein the machining device includes an attachment system for removably attaching the machining device to the workpiece; a machining tool for machining at least one region to be machined of the workpiece; a carriage for conveying the machining tool; and a rail shaped so as to guide the conveying carriage in translation along the region to be machined of the workpiece.

### TECHNICAL FIELD

The technical field of the invention is the repair of aircraft turbomachine workpieces. This invention concerns a device for machining an annular workpiece, in particular for a turbomachine, and a method for repairing such a workpiece.

### PRIOR ART

The turbomachines comprise various workpieces which, after use, may have zones damaged or worn by friction or erosion induced by the ingestion of particles carried by one or more air flux passing through the turbomachine or by impacts from foreign bodies. These defective, damaged or worn workpieces have their profiles modified, degrading the performance of both the workpiece and the turbomachine. In the worst case, these workpieces can break, which can cause major damage to the turbomachine. Frequently, when repairing aircraft turbomachine workpieces, problems arise regarding the accessibility of these workpieces. These problems exist, for example, for the annular flange between the engine and the reverser of a turbomachine, for which no repair solution is known to date. In the event of excessive wear, this annular flange is completely replaced, requiring the turbomachine to be dismantled in order to remove and replace the defective annular flange.

An aircraft is powered by several propulsion assemblies, each suspended from a fixed structure of the aircraft, for example under a wing or on the fuselage of the aircraft, via a suspension pylon. FIG. 1 illustrates such a propulsion assembly 1 comprising, as is known, a turbojet engine 2 equipped with a fan and an engine, and a nacelle 3 enveloping the turbojet engine and housing a thrust reverser.

The nacelle 3 generally has a tubular structure comprising an upstream section, or an air inlet 4 upstream of the turbojet engine 2, a middle section 5 designed to surround the turbojet engine fan, a downstream section 6 housing the thrust reverser and designed to surround a combustion chamber and the turbojet engine turbines, carrying the thrust reversing means, and is generally terminated by an ejection nozzle, the outlet of which is located downstream of the turbojet engine 2.

The downstream section 6 generally has an external structure comprising an external cover 7, which, together with a concentric internal structure (not visible in FIG. 1), known as the “Inner Fixed Structure” (IFS), defines the annular vein used to channel the flux of cold air. The internal structure defines an internal part of the annular vein, and generally comprises two half-shells connected together “at six o'clock” by means of a locking device.

The thrust reversal system allows the braking capacity of an aircraft to be improved during landing by redirecting most of the thrust generated by the turbojet engine forward. The external fixed structure of a thrust reverser comprises, in known manner, a peripheral front frame intended to be mounted on a fan casing of the corresponding turbojet engine, a peripheral rear frame, and a plurality of flow deflection grids fixed between the front and rear frames and extending substantially parallel to the longitudinal geometric axis of the thrust reverser. The front and rear frames are arranged transversely to the longitudinal geometric axis of the thrust reverser.

The front frame is connected to the fan casing by fastening means generally of the knife/throat type comprising a substantially annular flange, also known as an annular flange, made in one or more parts secured to the front frame and cooperating with a J- or V-shaped groove. Both the fastening assembly and the annular flange, which has a J- (or V-) shaped cross-section, are commonly referred to as the J-Ring.

There have been many cases of wear on annular flanges of this type due to friction between the annular flanges and the corresponding grooves in the fasteners. Excessive wear in this zone leads to interface problems such as play and vibrations.

The replacement of this annular flange, which is generally made of aluminium, is a complex, time-consuming and therefore costly operation. In fact, this operation requires dismantling the nacelle and many of its elements, as well as conveying it to a repair site. It would therefore be beneficial to find an alternative to replacing this workpiece, allowing it to be repaired under wing, i.e. while the workpiece is still installed on the turbomachine, and also allowing the aircraft to be released quickly.

A dynamic spray repair method, also known as “cold spray” or reloading, can be implemented using a direct jet nozzle that sprays metal powder at very high speeds, allowing damage to the surface of worn workpieces to be filled in.

However, such a repair method creates a deformed surface once reloading has been carried out.

FIG. 2 shows a cross-sectional view of the geometry of a J-ring type annular flange 110 and a zone Z of this annular flange 110 to be repaired. It can be seen that space is limited for inserting a machining tool. As a result, there is currently no machining device that can be inserted into this architecture without interfering with other components adjacent to the 110 annular flange. In other words, the geometry of the “J-Ring” type annular flange 110 makes it impossible to use a conventional machining device, especially when the annular flange remains installed on the aircraft.

The aim of the present invention is therefore to propose a device for machining an annular workpiece such as a J-ring type annular flange, enabling the original profile of the workpiece to be recovered and controlled, while overcoming at least some of these disadvantages.

### SUMMARY OF THE INVENTION

To this end, the invention relates to a device for machining an annular workpiece, in particular for a turbomachine, characterized in that the machining device comprises:
a fastening system for removably fastening the machining device to the workpiece;
a machining tool for machining at least one zone of the workpiece to be machined;
a carriage for conveying the machining tool; and
a rail shaped so as to guide the conveying carriage in translation along the zone to be machined of the workpiece, the rail being flat and having the shape of an arc of a circle.

The invention thus offers a solution to the above-mentioned problems, allowing to overcome the above-mentioned problems of accessibility and size in order to repair under-wing a turbomachine workpiece of the “J-Ring” type, or any other type of workpiece whose geometry does not allow the use of a conventional machining device. Thanks to the invention, it is possible to position the machining device according to the invention so that the machining tool can easily access the surface of the workpiece to be repaired despite the geometry of the workpiece and the restricted accessibility to the zone to be repaired. The machining device according to the invention thus allows the annular workpiece, such as a annular flange of a turbomachine, to be repaired by restoring the original profile and characteristics of the workpiece while the workpiece remains installed on the turbomachine, which itself remains under the wing of the aircraft. As a result, it is no longer necessary to dismantle the aircraft's turbomachine, enabling the aircraft to be released more quickly than is currently the case. The machining device according to the invention can also be used to repair the annular flange on equipment removed from the turbomachine, in a workshop for example.

Such a machining device according to the invention has the advantage of being easily conveyed to the aircraft site equipped with such an annular workpiece to be repaired. So there's no need to dismantle and convey the nacelle to a repair shop. This means the machining device can be used quickly. In the event of a workshop repair, it eliminates the need to convey the equipment and allows the operation to be carried out in any workshop if necessary. It also has the advantage of being fixed directly to the part to be repaired, so that it can easily be restored to its original surface profile.

The machining device according to the invention may comprise one or more of the following characteristics, taken in isolation from each other or in combination with each other in any technically possible combination:
the machining device also comprises a system for moving the conveying carriage on the rail along the zone of the workpiece to be machined;
the movement system comprises a drive element for moving the conveying carriage on the rail, preferably a rack-type drive element;
the system for moving the conveying carriage on the rail comprises a manual or electric feed system;
the conveying carriage comprises a plate extending parallel to the rail and at least three rollers arranged on the plate, at least two of the rollers are configured to cooperate with a first guide track of the rail and at least one of the rollers is configured to cooperate with a second guide track of the rail, the two guide tracks are each arranged on an inner circumferential edge of the rail and an outer circumferential edge of the rail;
the rail is arranged between at least one radially outer roller and one radially inner roller;
each roller comprises a groove adapted to receive one of the guide tracks of the rail, preferably the groove has a V-shaped cross-section and the guide tracks have a complementary shape;
each guide track of the rail comprises a groove adapted to receive one of the rollers, preferably the groove has a V-shaped cross-section and each roller has at its circumferential end a protuberance of complementary shape to that of the groove;
the plate and the machining tool are arranged on either side of the rail, in particular in the plane of the rail when the conveying carriage is arranged on the rail;
the movement system and the machining tool are arranged on either side of the rail;
the machining device comprises a tool for geometric control of the zone to be machined of the workpiece and wherein the conveying carriage is configured to support the geometric control tool;
the fastening system configured to fasten the machining device to the workpiece comprises at least one workpiece fastening flange, preferably two workpiece fastening flanges each arranged at one end of the rail, to hold the rail in position relative to the workpiece;
each fastening flange is shaped to hold the rail in position relative to the workpiece in an axial direction parallel to the axis of revolution of the annular workpiece;
the fastening system comprises at least one additional fastening element, preferably two additional fastening elements each arranged at one end of the rail, the additional fastening element or elements are configured to fasten the rail to a frame supporting the workpiece;
each additional fastening element is shaped to hold the rail in position with respect to the workpiece in a radial direction perpendicular to the axis of revolution of the annular workpiece;
each additional fastening element comprises two arms extending perpendicularly to each other: a first arm extending radially outwards from a first end fixed to the rail and comprising a second end opposite the first end, and a second arm, extending perpendicularly to the first arm and comprising a first end connected to the second end of the first arm and a second end opposite the first end of the second arm and comprising means for fastening to the frame.
the conveying carriage comprises a system for positioning the machining tool relative to a zone to be machined of the workpiece.

The invention also relates to a method of repairing a turbomachine annular flange, the annular flange having a damaged zone, the repair method comprising the following steps:
a step of reloading material into the damaged zone of the annular flange to form a reloaded zone of the annular flange;
a step of machining the reloaded zone of the annular flange to obtain a repaired zone of the annular flange, this step being implemented by a machining device according to the invention and as described previously.

The machining method according to the invention may comprise one or more of the following characteristics, taken in isolation from each other or in combination with each other in any technically possible combination:
the annular flange is installed on a turbomachine during the repair method;
the method comprises a step of moving the machining device opposite the reloaded zone of the annular flange and a step of fastening the rail to at least the annular flange;
the method comprises a step of moving the carriage for conveying the machining tool opposite the reloaded zone of the annular flange;
the method comprises a step of positioning the machining tool so as to machine the reloaded zone of the annular flange to obtain a repaired zone of the annular flange.

### BRIEF DESCRIPTION OF FIGURES

The invention will be better understood and other details, characteristics and advantages of the present invention will become clearer from the following description made by way of non-limiting example and with reference to the attached drawings, wherein:

FIG. 1, already described, is a schematic three-dimensional view of a propulsion assembly comprising an annular workpiece that may require repair;

FIG. 2, already described, is a profile view of an annular flange comprising a damaged zone in need of repair;

FIG. 3 schematically represents a machining device according to one example of the invention;

FIG. 4 shows a perspective view of the machining device shown in FIG. 3 in its functional position;

FIG. 5 shows a cross-sectional profile view of the machining device shown in FIG. 3 in its functional position;

FIG. 6 is an enlarged view of FIG. 5 at the level of the machining tool;

FIG. 7 is a view of the cutting tool of the machining device in FIG. 3 in the functional position for repairing a “J-Ring” type annular flange;

FIG. 8 shows the end of a “J-Ring” type annular flange in its initial state before wear;

FIG. 9 shows the end of the “J-Ring” type annular flange in the FIG. 8 with a worn zone;

FIG. 10 illustrates the result of a reloading step on the worn zone of the end of the J-ring-type ring flange shown in FIG. 9; and

FIG. 11 illustrates the result of a machining step carried out by the machining device according to the invention on the reloaded zone of the end of the “J-Ring” type annular flange in FIG. 10.

The elements with the same functions in the different implementations have the same references in the figures.

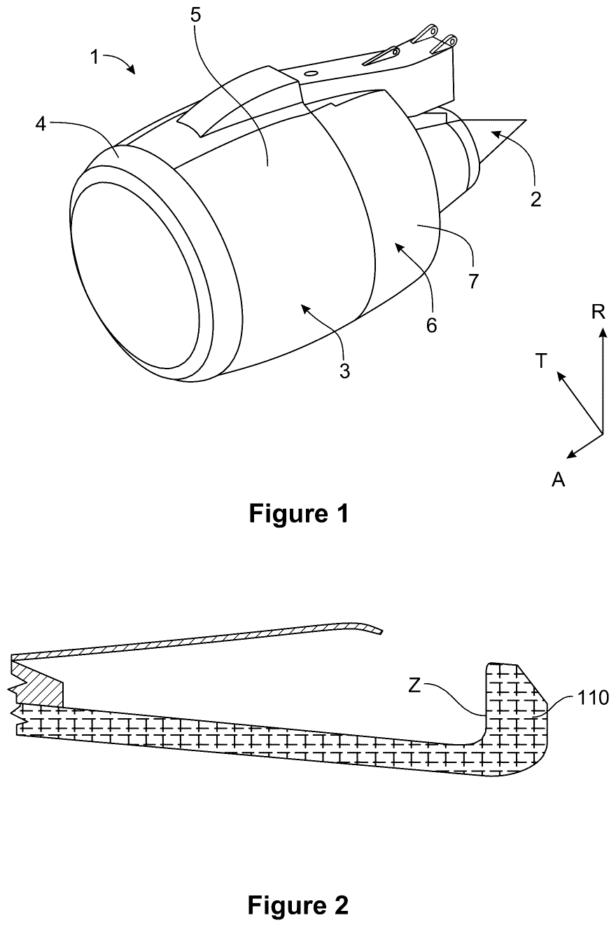

In the description and in the claims, the terms “upstream” and “downstream” are defined in relation to the flux of air inside the propulsion assembly formed by the nacelle and the turbojet engine, i.e. from left to right, with reference to FIG. 1. Similarly, the terms “internal” or “inside” and “external” or “outside” will be used without limitation to refer to the radial distance from the longitudinal axis of the nacelle, the term “internal” defining a zone radially closer to the longitudinal axis of the nacelle, as opposed to the term “external”. Furthermore, to clarify the description and the claims, the terms axial, radial and transverse will be adopted with reference to the A, R, T trihedron shown in the figures.

### DESCRIPTION OF THE EMBODIMENTS

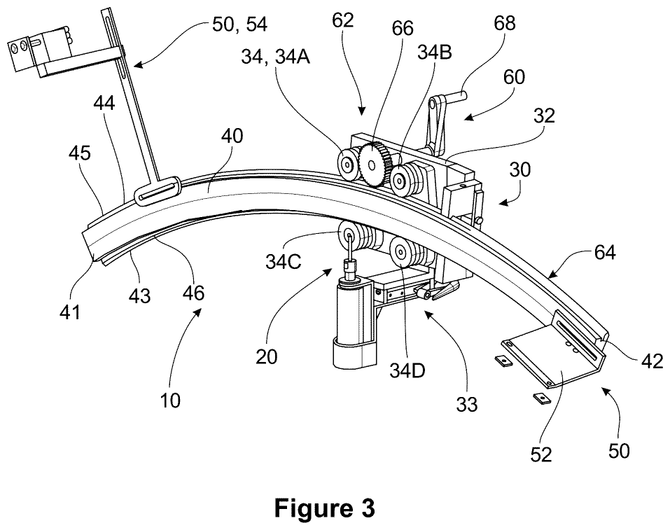

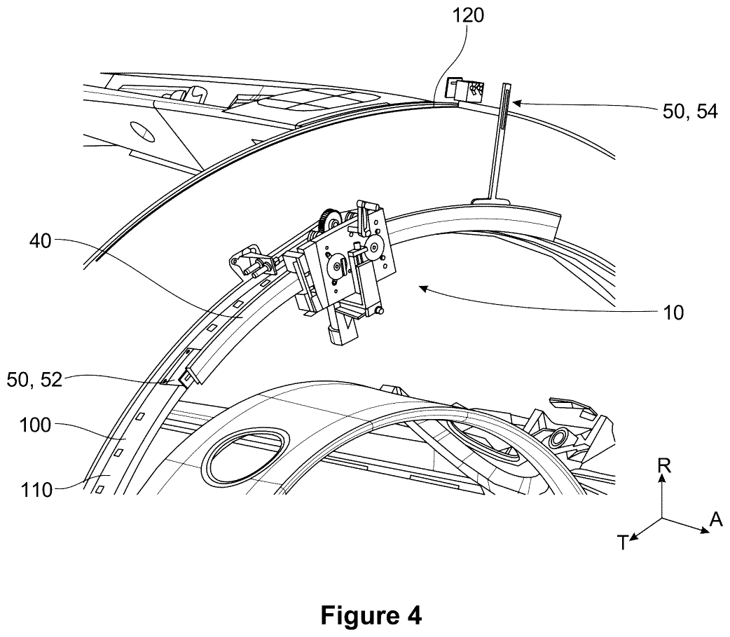

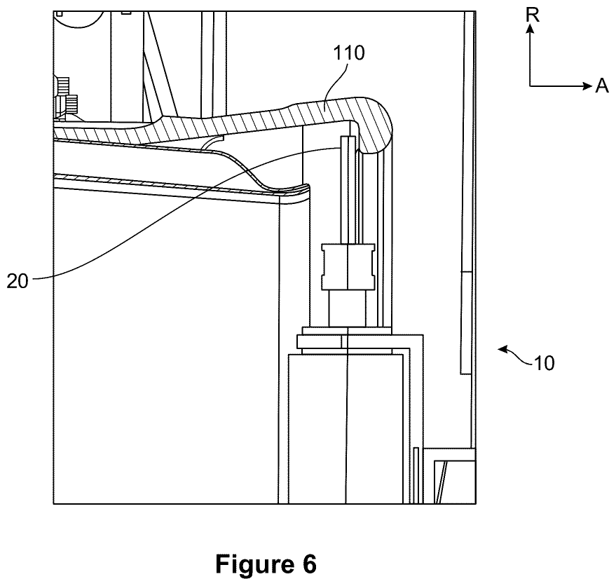

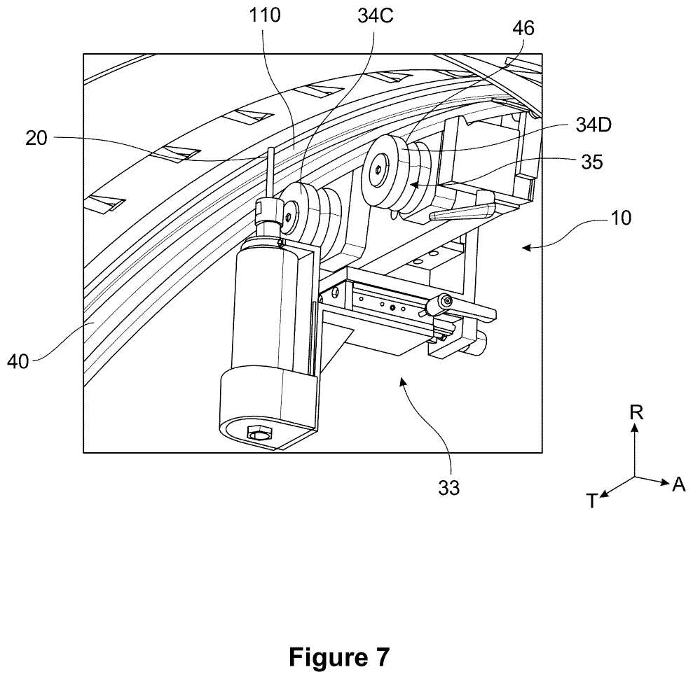

Reference is made to FIG. 3, which illustrates a machining device according to one embodiment of the invention, and to FIGS. 4 to 7, which show views of the device of FIG. 3 in its functional position, i.e. arranged so as to be able to machine an annular workpiece 100, in particular for a turbomachine.

As mentioned previously, such a turbomachine comprises annular workpieces that may require repair of damaged zones that are difficult to access.

In particular, a thrust reverser comprises means for attaching the front frame to the turbomachine comprising a J-ring type annular flange, due to its J or V shape.

In the example shown in FIGS. 4 to 7, the annular workpiece 100 is a J-Ring type annular flange 110 of the thrust reverser.

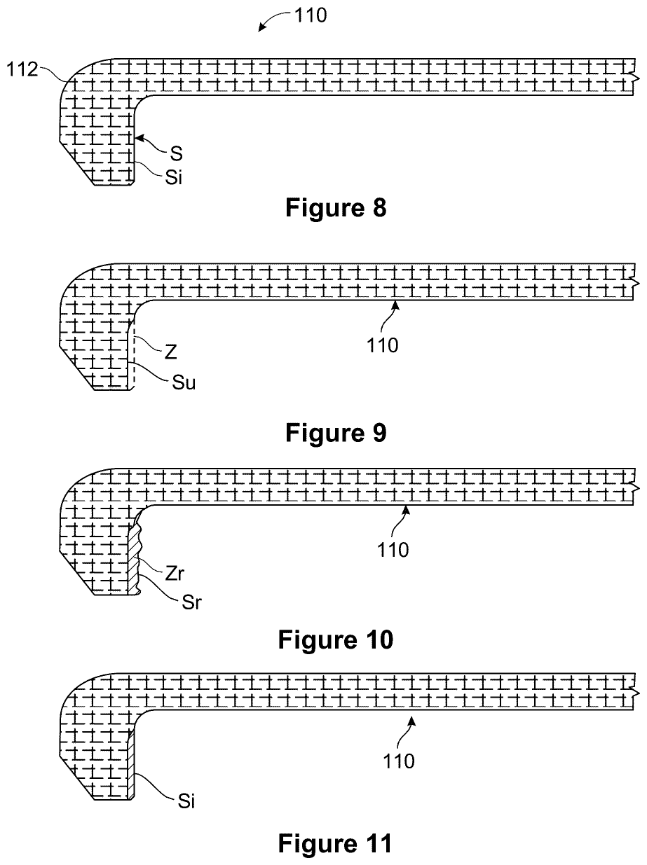

Such an annular flange 110 is also shown in FIG. 8 and comprises a J- or V-shaped bent or curved end 112 with a surface S that is subject to wear during use. As a result, the surface may have a damaged zone as shown in FIG. 9. It is clear from FIGS. 8 and 9 that the annular flange to be machined comprises an annular body extending axially between a first end and a second end. The axial direction is the direction parallel to the axis of symmetry of the annular flange, which is generally coincident with the longitudinal axis of the turbomachine module or of the turbomachine itself to which the annular flange is fitted. As previously indicated, one of the ends is folded or curved into a J-shape or a V-shape. In other words, the annular flange comprises a rim extending at least radially from the body and more precisely from the first end of the body towards a third end in order to give the end 112 of the annular flange a folded or curved J-shape. The rim may further extend both radially and towards the second end to give the end 112 of the annular flange a folded or curved V-shape. The rim therefore extends between the first end of the body and the third end. The rim has a first face and a second face, the second face being closer to the second end of the body of the annular flange. This second face comprises a zone Z to be machined and/or repaired that is difficult to access using the machining devices of the previous technique.

The machining device according to the invention is suitable for repairing workpieces made of an aluminium alloy, titanium or other metallic materials.

FIG. 3 shows schematically an example of a device for machining 10 an annular workpiece according to the invention. The annular workpiece is rotationally symmetrical about an axis of revolution.

Such a machining device 10 comprises:
a machining tool 20 for machining at least one zone of the workpiece to be machined;
a carriage 30 for conveying the machining tool 20; and
a rail 40 designed to guide the conveying carriage 30 in translation along the zone of the workpiece to be machined.

The machining tool 20 is a tool such as a drill, pneumatic or electric drill, milling cutter or abrasive disc, chosen according to the zone of the workpiece to be machined.

The machining device 10 comprises a fastening system 50 for fastening the machining device to the workpiece, in this case to the annular flange 110, in a removable manner. Advantageously, the fastening system 50 comprises at least one flange 52 for fastening to the workpiece 100 to hold the rail in position relative to the workpiece in an axial direction A parallel to the axis of revolution of the annular workpiece. In the example shown in FIGS. 3 and 4, such a fastening flange 52 comprises a substantially flat platen extending in a plane substantially perpendicular to the rail 40 of the machining device. The platen is fixed to the workpiece and to the rail 40 by fastening means such as screw/nut systems.

Preferably, the fastening system 50 comprises two flanges 52 for fastening to the workpiece, each arranged at one end of the rail 40.

Advantageously, the fastening system 50 comprises at least one additional fastening element 54 for fastening the rail to a frame 120 supporting the workpiece. In the case of the annular flange 110, the additional fastening element 54 enables the positioning system to be fixed to the frame supporting the annular flange 110 and thus guarantees its positioning in a so-called radial direction R perpendicular to the axis of revolution of the annular workpiece. To this end, the additional fastening element 54, in the example shown in FIGS. 3 and 4, comprises two arms extending perpendicular to each other:
a first arm extending radially outwards from a first end fixed to the rail 40, and in particular to an outer edge 44 of the rail 40, and comprising a second end opposite the first end, and
a second arm, extending perpendicularly to the first arm and comprising a first end connected to the second end of the first arm and a second end opposite the first end of the second arm and comprising means of attachment to the frame 120, for example a screw/nut type system.

Advantageously, the second arm can be linked to the first arm by a radial-axis sliding connection, making it easier to attach the machining device to the frame 120, in particular by adapting the additional attachment element to the dimensions of the frame. For this purpose, the first arm can also be moved along the rail.

Preferably, the fastening system comprises two additional fastening elements 54, each arranged at one end of the rail 40 and as described above.

For example, the fastening flange(s) 52 and the additional fastening element(s) 54 are clamped to the annular workpiece and the frame respectively.

The rail 40 has a circular or arcuate shape with a radius substantially equal to that of the annular workpiece so that it can be juxtaposed with it. Thus, once the machining device has been installed and fixed to the annular workpiece, the geometric centre of the arc of a circle forming the rail 40 belongs to the axis of revolution of the annular workpiece.

The rail 40 extends over an angular portion with angles of between 60° and 180°. Preferably, the rail 40 extends over an angular sector of 60°, enabling, for example, one half of the annular workpiece to be covered by moving the rail only three times. The size of the rail means that it can be easily conveyed and used anywhere in the world where the equipment is positioned.

The rail 40 extends between a first end 41 and a second end 42 opposite the first end 41.

In the embodiment shown in FIGS. 3 to 7, the rail 40 extends radially between an inner circumferential edge 43 and the outer circumferential edge 44. The inner 43 and outer 44 edges of the rail define a principal plane perpendicular to the axis of revolution of the annular workpiece when the machining device is installed and fixed to the annular workpiece. A main rail axis is defined as an axis perpendicular to the main plane of the rail and passing through its geometric centre. Thus, when the machining device is installed and fixed to the annular workpiece, the main axis of the rail and the axis of revolution of the annular workpiece to be machined are coincident. Thus, we understand clearly from FIGS. 3 to 5, in particular, that the rail 40 is flat since it is contained within the main plane and has a circular arc shape in this plane, more precisely a circular ring gear shape. In this main plane, the rail 40 extends between two portions of concentric circles of different radii, namely the inner circumferential edge 43 and the outer circumferential edge 44.

The conveying carriage 30 has a plate 32 or support configured to support the machining tool 20.

Advantageously, the conveying carriage 30 comprises a positioning system 33 supported by the plate 32. The positioning system 33 is configured to position the machining tool 20 with a high degree of precision in three mutually perpendicular directions in relation to the zone of the workpiece to be machined. The positioning system 33 comprises adjustment means, such as micrometric screws, and means for locking the machining tool 20 in position relative to the zone to be machined.

In the illustrated embodiment, when the conveying carriage is arranged on the rail 40, the plate 32 extends in a plane parallel to the main plane of the rail, i.e. in a plane transverse to the main axis of the rail.

The plate 32 and the machining tool 20 are arranged on either side of the rail, in particular the main plane of the rail when the conveying carriage is arranged on the rail 40, so that the machining tool 20 has access to the surface to be machined of the annular workpiece when the machining device is installed and fixed to the annular workpiece.

The conveying carriage 30 is movable on the rail 40. Advantageously, the machining device 10 includes a system 60 for moving the conveying carriage 30 on the rail 40 along the zone of the workpiece to be machined.

Advantageously, the movement system 60 comprises a drive element 62 for moving the conveying carriage 30 on the rail 40.

In the example of the machining device 10 shown in FIGS. 3 to 7, the drive element 62 is, for example, a rack-type drive element.

Thus, in the illustrated example, the drive element 62 comprises a toothed bar arranged on the rail 40 and a gear wheel 66 arranged on the plate 32 of the conveying carriage 30 and configured to cooperate with the toothed bar of the rail by meshing with the teeth of the toothed bar. The gear wheel 66 extends parallel to the plate 30.

Preferably, the movement system 60, in particular the gear wheel of the drive element, and the machining tool 20 are arranged on either side of the rail 40. More specifically, the machining tool 20 is arranged so as to be closer to the main axis of the rail than the movement system in order to minimise the size of the machining device and guarantee the machining tool access to the zone to be machined and in order to balance the masses of the various elements of the machining device and thus guarantee optimum movement.

The travel system 60 of the conveying carriage on the rail comprises a feed system on the rail 40. In the example shown, the feed system is manual and comprises a crank 68 configured to rotate the gear wheel 66 of the drive element.

Alternatively, the feed system can be electric and comprise an electric motor configured to rotate the gear wheel 66 of the drive element.

Advantageously, the conveying carriage 30 has at least three rollers arranged on the plate 32. The rollers, of general reference 34, are each rotatable about an axis of rotation perpendicular to the plate 32. At least two of the rollers are configured to cooperate with a guide track 45 of the rail and at least one of the rollers is configured to cooperate with another guide track 46 of the rail. The two guide tracks 45, 46 are each arranged on the inner edge 43 and the outer edge 44 of the rail.

In the example shown in the figures, four rollers 34A, 34B, 34C and 34D are supported by the plate of the conveying carriage. The rollers 34A and 34B are arranged radially outwards with respect to the rail 40, while the rollers 34C and 34D are arranged radially inwards with respect to the rail 40. In other words, the rail 40 is arranged between the pair of radially outer rollers 34A, 34B and the pair of radially inner rollers.

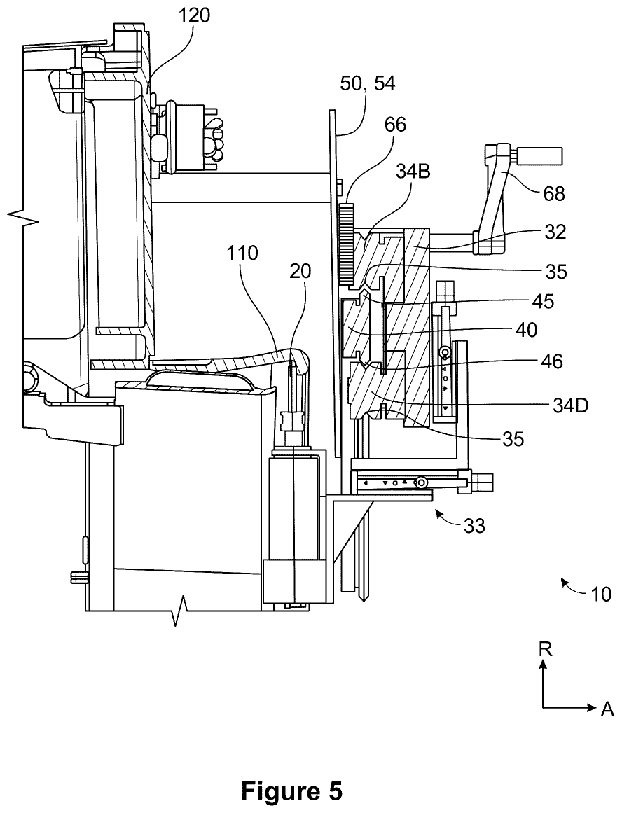

FIG. 5 shows a sectional view of the machining device in its functional position in the cutting plane passing through the axes of rotation of the rollers 34B and 34D.

In the example shown, each roller comprises a groove 35 adapted to receive one of the guide tracks 45, 46 of the rail, as can be seen more clearly in the sectional view shown in FIG. 4. In the example shown, the groove has a V-shaped cross-section and the guide tracks 45, 46 have a complementary, triangular shape. However, there are other shapes for the groove and therefore for the complementary shape of the guide track. Alternatively, each guide track may comprise a groove and each roller may have a protuberance at its circumferential end, the shape of which complements that of the groove.

Advantageously, the machining device 10 may comprise a geometric control tool (not shown) configured to control the geometric profile of the machined/machinable surface of the machinable zone of the workpiece. In this case, the conveying carriage 30 is configured to support said geometric control tool.

The geometric control tool is, for example, a mechanical or electronic micrometer, possibly with a system for recording the position of the zone to be machined and the profile of the surface before and after machining.

We now describe a method for repairing a turbomachine annular flange, for example of the “J-Ring” type. The annular flange 110 comprises a J- or V-shaped bent or curved end 112 with a surface S which is subject to wear during use. The front annular flange before use is shown in FIG. 8 and has an initial surface profile marked ‘Si’.

After use, the annular flange has worn/damaged zones as shown in FIG. 9, with a loss of material compared to the original profile. Such a damaged zone Z has a surface profile marked ‘Su’ and must be repaired.

The repair method comprises a step of reloading material into the damaged zone of the annular flange to form a reloaded zone Zr of the adapter ring with a gain in material compared with the damaged zone shown in FIG. 9.

During this reloading stage, the damaged zone Z is coated with metal powder by a dynamic spraying device suitable for reloading the zone.

Advantageously, this step can be carried out without removing the annular flange, i.e. while the annular flange is installed on the turbomachine using a dynamic gas spraying device as described in the patent application FR 2 209 900. So there's no need to dismantle the unit, which saves a considerable amount of time.

FIG. 10 shows the result of this step. The damaged zone with a surface profile ‘Su’ (FIG. 9) was recharged to form a recharged zone Zr with a surface profile ‘Sr’.

In order to recover the initial surface profile ‘Si’, the reloaded zone is machined during a machining step carried out by a machining device according to the invention and as described previously. To this end, the machining device is fixed to the workpiece opposite the zone to be machined by means of the fastening 50 the device and the machining tool 20 is moved on the rail by translation in order to place it opposite the zone for machining.

The result of this step is shown schematically in FIG. 11. The recharged zone Zr with a surface profile ‘Sr’ (FIG. 10) was machined to recover the original profile ‘Si’ of FIG. 8.

Advantageously, this step can also be carried out without removing the annular flange, i.e. while the annular flange is installed on the turbomachine. So there's no need to dismantle the unit, which saves a considerable amount of time.

The position of the conveying carriage 30 and/or that of the machining tool 20 are modified as many times as necessary in order to repair all the damaged zones of the annular flange accessible by the tool in this position of the machining device relative to the annular flange.

The machining device is then moved again and fixed opposite another portion of the annular flange comprising reloaded zones to be machined in order to cover this other portion of the annular flange accessible by the machining tool.

In particular, the machining device is positioned and the rail of the machining device is fixed from the rail at least to the annular flange and preferably also to the frame supporting the annular flange.

In the case where the machining device comprises at least one flange 52 for fastening to the workpiece 100, preferably two, to hold the rail in position relative to the workpiece in the axial direction A parallel to the axis of revolution of the annular workpiece, the machining step advantageously comprises a step of positioning the machining device opposite the reloaded zone of the annular flange followed by a step of fastening the rail to the flange. In particular, the rail 40 is fixed to the annular flange 110 via at least one platen. The platen(s) are fixed to the workpiece 110 and to at least one of the ends of the rail 40, preferably to each end of the rail 40, by fastening means such as screw/nut systems, with reference to FIGS. 3 to 5. In the preferred case where the fastening system 50 comprises two flanges 52 for fastening to the workpiece, these are each arranged at a separate end of the rail 40.

Furthermore, in the event that the machining device also comprises at least one additional fastening element 54 for fastening the rail 40 to a frame 120 supporting the workpiece, the machining step advantageously also comprises a step of fastening the rail 40 to such a frame 120 in order to guarantee its positioning in the radial direction R perpendicular to the axis of revolution of the annular workpiece. In this case, and in the example shown, each second arm of the additional fastening elements 54 is fixed to the frame 120 supporting the workpiece 100 by fastening means, for example a screw/nut type system.

In this way, the additional fastening element(s) 54 enable the positioning system to be fixed to the frame supporting the annular flange 110 and thus guarantee its positioning in a so-called radial direction R perpendicular to the axis of revolution of the annular part. In the preferred case where the fastening system 50 comprises two additional fastening elements 54, these are each arranged at a different end of the rail 40.

For example, the fastening flange(s) 52 and the additional fastening element(s) 54 are clamped to the annular workpiece and the frame respectively.

According to the embodiment of the machining device in which the latter comprises a system 60 for moving the conveying carriage on the rail, the machining step comprises, after the step of fastening the machining device to the workpiece to be machined and, if necessary, also to the frame supporting the workpiece, a step of displacing the conveying carriage 30 of the machining tool 20 by the movement system in order to position it opposite the reloaded zone of the annular flange 110. Its position is then advantageously locked to the rail by a locking means on the conveying carriage. In this way, the machining tool 20 is first positioned opposite the zone to be machined by the movement of the conveying carriage 30 supporting it along the rail by the movement system 60 as described previously.

Advantageously, the conveying carriage is driven in its movement by the drive element 62 of the movement system 60, for example by a rack/gear wheel system.

In the case where the movement system 60 advantageously also comprises a system for advancing on the rail 40, the conveying carriage 30 can be easily moved along the rail manually by means of the crank 68 linked to the gear wheel or electrically by means of a motor to manoeuvre said gear wheel 66.

The machining tool 20 is then positioned with great precision in three mutually perpendicular directions with respect to the reloaded zone of the annular flange of the workpiece to be machined by the positioning system 33 supported by the plate 32 of the conveying carriage 30 to obtain a repaired zone of the annular flange.

The plate 32 and the machining tool 20 are arranged on either side of the rail, in particular the main plane of the rail when the conveying carriage is arranged on the rail 40, so that the machining tool 20 has access to the surface to be machined of the annular workpiece when the machining device is installed and fixed to the annular workpiece.

Its position is preferably locked before machining of the zone begins, by means of a system for locking the position of the machining tool.

In addition, the method can advantageously comprise a checking step, using a geometric checking tool supported by the conveying carriage 30, to check the geometric profile of the surface of the zone of the workpiece to be machined or of the machined zone of the workpiece.

It should be noted that the examples illustrated in the figures are by no means limitative; the repair process described above for an annular flange can be adapted to any other component whose shape and arrangement in a turbomachine does not allow machining under the wing, i.e. when the workpiece remains installed on the turbomachine.

The machining device is suitable for machining all types of annular parts made of aluminium alloy, titanium or other metallic materials.

The advantage of this type of machining device according to the invention is that it can be easily conveyed to the site where the annular part to be repaired is to be fitted. So there's no need to dismantle and convey the nacelle to a repair shop. This means the machining device can be used quickly. It also has the advantage of being fixed directly onto the workpiece to be retouched, so that it can easily regain its original surface profile.

1. A device for machining an annular workpiece, in particular for a turbomachine, wherein the machining device comprises:
a fastening system for removably fastening the machining device to the workpiece;
a machining tool for machining at least one zone of the workpiece to be machined;
a carriage for conveying the machining tool; and
a rail shaped to guide the conveying carriage in translation along the zone of the workpiece to be machined, the rail being flat and having the shape of an arc of a circle.

2. The machining device according to claim 1, further comprising a system for moving the conveying carriage on the rail along the zone of the workpiece to be machined.

3. The machining device according to claim 2, wherein the movement system comprises a drive element for moving the conveying carriage on the rail, preferably a rack-type drive element.

4. The machining device according to claim 2, wherein the system for moving the conveying carriage on the rail comprises a manual or electric feed system.

5. The machining device according to claim 1, wherein the conveying carriage comprises a extending parallel to the rail and at least three rollers arranged on the plate, at least two of the rollers are configured to cooperate with a first guide track of the rail and at least one of the rollers is configured to cooperate with a second guide track of the rail, the two guide tracks are each arranged on an inner circumferential edge of the rail and an outer circumferential edge of the rail.

6. The machining device according to claim 1, comprising a tool for geometric control of the zone to be machined of the workpiece and wherein the conveying carriage is configured to support the geometric control tool.

7. The machining device according to claim 1, wherein the fastening system configured to fasten the machining device to the workpiece comprises at least one workpiece fastening flange, preferably two workpiece fastening flanges each arranged at one end of the rail, to hold the rail in position relative to the workpiece.

8. The machining device according to claim 1, wherein the fastening system comprises at least one additional fastening element, preferably two additional fastening elements each arranged at one end of the rail, the additional fastening element or elements are configured to fasten the rail to a frame supporting the workpiece.

9. The machining device according to claim 1, wherein the conveying carriage comprises a system for positioning the machining tool relative to a zone of the workpiece to be machined.

10. A method of repairing an annular flange of a turbomachine, the annular flange having a damaged zone, the repair method comprising the following steps:
a step of reloading material into the damaged zone of the annular flange to form a reloaded zone of the annular flange;
a step of machining the reloaded zone of the annular flange to obtain a repaired zone of the annular flange, this step being implemented by a machining device according to claim 1.
